(19) United States
(12) Patent Application Publication
(10) Pub. No.: US 2014/0075837 A1
(43) Pub. Date: Mar. 20, 2014

(54) Plant Watering Device

(71) Applicant: Donald W. Little, Shreveport, LA (US)

(72) Inventor: Donald W. Little, Shreveport, LA (US)

(21) Appl. No.: 13/621,594

(22) Filed: Sep. 17, 2012

(51) Int. Cl. A01G 27/02

(52) U.S. Cl. 47/48.5

(57) ABSTRACT

A plant watering device includes a device insert having a substantially solid porous material with a continuously porous exterior contact surface, at least one watering cavity in the device insert and a water distribution conduit disposed in fluid communication with the at least one watering cavity.

### FIELD

Illustrative embodiments of the disclosure generally relate to devices for watering plants. More particularly, illustrative embodiments of the disclosure relate to a plant watering device which can be inserted in a plant growing medium to maintain a steady supply of water and/or liquid fertilizer or the like to the medium.

### BACKGROUND

A variety of flowers and other types of decorative plants or food plants are commonly grown or displayed in homes or other settings for decorative, food or other purposes. Plants may be grown in soil or other plant growing medium which is contained in a flower pot, a hanging basket, a box container or other suitable vessel. A regular supply of water typically must be delivered to the soil to maintain optimum health of the plant or plants in the soil. The soil may also require periodic fertilization for optimum health of the plant or plants.

A common method of watering plants includes periodically dispensing water from a hand-held watering can, garden hose or the like. This technique, however, may be laborious and time-consuming since a large number of plants may be scattered over a large area and each and every one of the plants may need to be watered multiple times per day.

### SUMMARY

The disclosure is generally directed to a plant watering device. An illustrative embodiment of the plant watering device includes a device insert having a substantially solid porous material with a continuously porous exterior contact surface, at least one watering cavity in the device insert and a water distribution conduit disposed in fluid communication with the at least one watering cavity.

The disclosure is further generally directed to a plant watering system. An illustrative embodiment of the plant watering system includes a water source; a plurality of interconnected plant watering devices each including a device insert having a substantially solid porous material with a continuously porous exterior contact surface, at least one watering cavity in the device insert and a water distribution conduit disposed in fluid communication with the at least one watering cavity and with the water source; and a hose establishing fluid communication between the water distribution conduit of each of the plant watering devices and the water distribution conduit of each adjacent one of the plant watering devices.

### BRIEF DESCRIPTION OF THE DRAWINGS

Illustrative embodiments of the disclosure will now be described, by way of example, with reference to the accompanying drawings, in which:

FIG. 1 is a perspective view of an illustrative embodiment of the plant watering device;

FIG. 2 is a front view of an illustrative embodiment of the plant watering device;

FIG. 3 is a longitudinal sectional view of an illustrative embodiment of the plant watering device;

FIG. 4 is a side view of a plant container with a plant growing medium in the container, a plant growing in the plant growing medium and a plant watering device inserted in the plant growing medium in exemplary application of the plant watering device;

FIG. 5 is a sectional view of the plant container and the plant watering device inserted in plant growing medium in the plant container, more particularly illustrating flow of water from the plant watering device into the plant growing medium in exemplary application of the plant watering device;

FIG. 6 is a side view of a string of multiple connected plant watering devices coupled to a faucet and inserted in respective plant containers in exemplary application of the plant watering devices in a plant watering system; and

FIG. 7 is a sectional view of a string of connected first, second and third plant watering devices, more particularly illustrating placement of a liquid fertilizer in the first plant watering device and flow of the liquid fertilizer with water to the second and third plant watering devices, respectively, in exemplary application of the plant watering devices.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description. Relative terms such as “upper”, “lower”, “above”, “below”, “top”, “horizontal” and “vertical” as used herein are intended for descriptive purposes only and are not necessarily intended to be construed in a limiting sense.

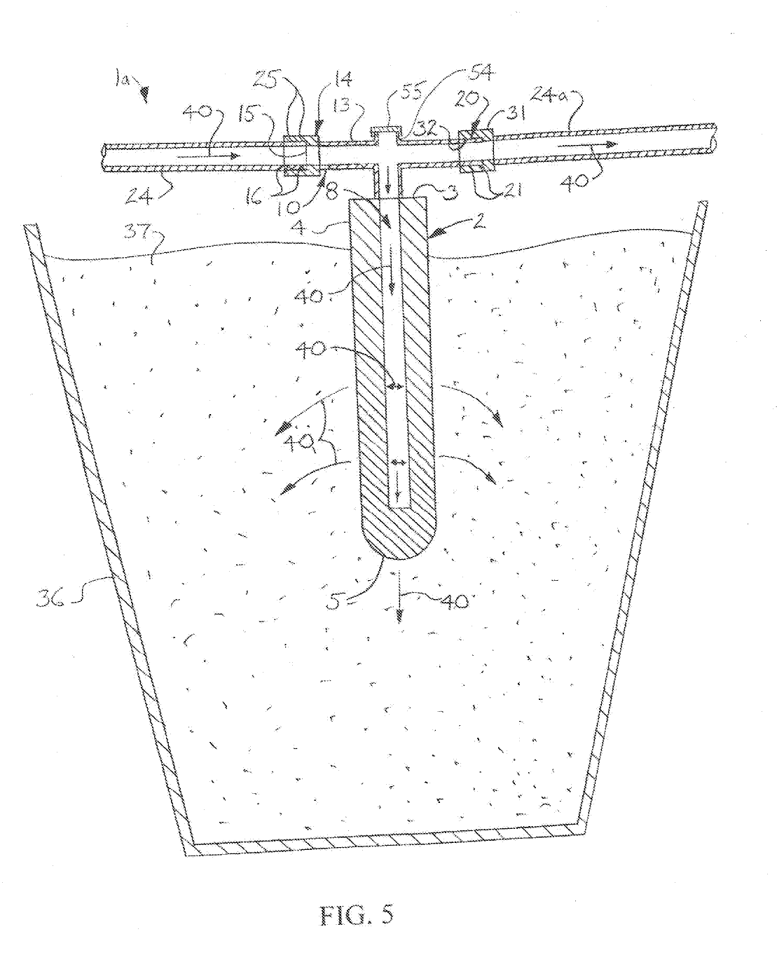

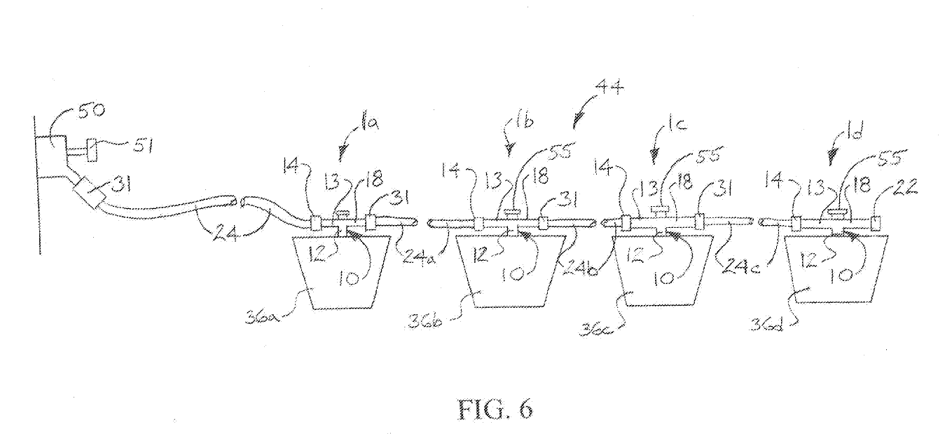

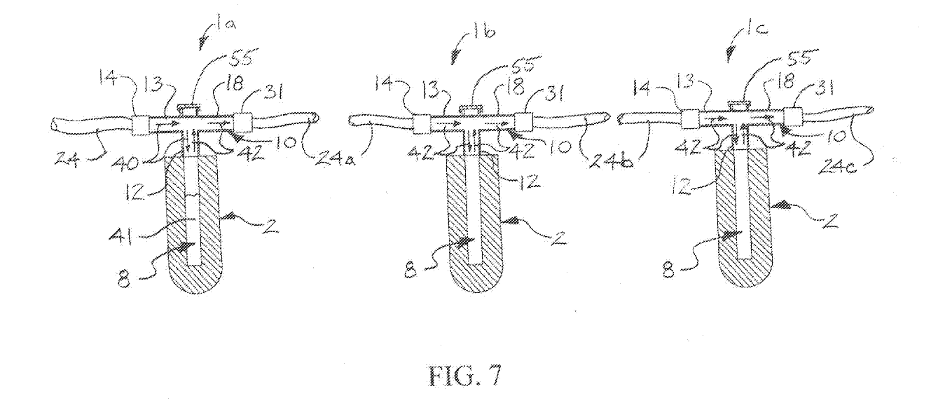

Referring to the drawings, an illustrative embodiment of the plant watering device is generally indicated by reference numeral 1. As illustrated in FIGS. 4-6 and will be hereinafter further described, in exemplary application at least one plant watering device 1 may be inserted in a plant growing medium 37. In some applications, the plant growing medium 37 may be contained in a plant container 36 such as a flower pot, a hanging basket, a box container or the like and sustains the life of at least one plant 38. In other applications, the plant growing medium 37 may be placed in a garden or the like. The plant growing medium 37 may be any type of medium which is capable of sustaining the life of one or more plants 38 and includes but is not limited to dirt, sand, peat, sphagnum, compost and perlite. A faucet 50 (FIG. 6) or other suitable source of water may be connected to the plant watering device 1, which facilitates distribution of water 40 (FIG. 5) from the faucet 50 into the plant growing medium 37. In some applications, the plant watering device 1 may facilitate distribution of fertilizer (not illustrated) from a suitable source of fertilizer into the plant growing medium 37. As illustrated in FIG. 6, in some applications, multiple plant watering devices (designated by reference numerals 1a, 1b, 1c and 1d, respectively) may be connected to each other in series to facilitate distribution of the water 40 to plant growing medium 37 contained in multiple plant containers 36a-36d.

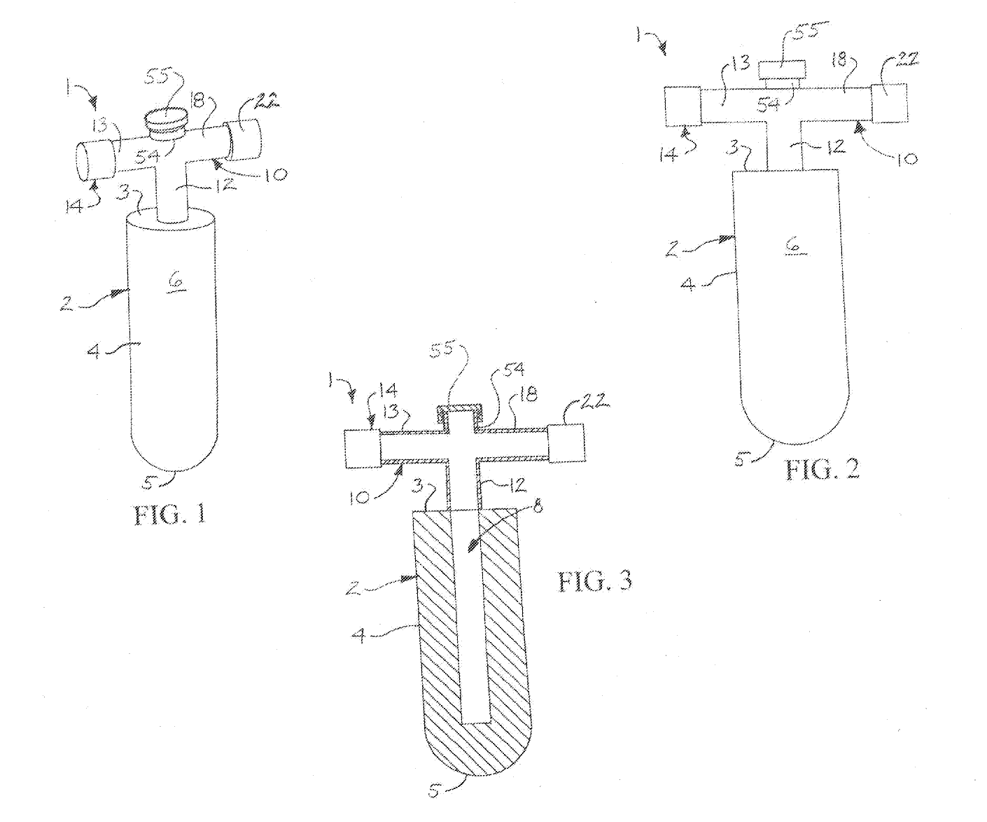

As illustrated in FIGS. 1-3, the plant watering device 1 includes a device insert 2 which may be generally elongated, as illustrated. In some embodiments, the device insert 2 may have a generally flat or planar upper insert surface 3, a generally elongated and cylindrical side insert surface 4 and a generally rounded lower insert surface 5. As illustrated in FIGS. 1 and 2, the side insert surface 4 of the device insert 2 may have a continuously porous exterior contact face 6 which may be disposed in direct contact with the plant growing medium 37 (FIG. 5) in application of the plant watering device 1. As used herein, “continuously porous” shall be construed to indicate that pores are present substantially throughout the surface area of the exterior contact face 6. In alternative embodiments, the device insert 2 may have alternative shapes. For example and without limitation, in some embodiments the device insert 2 may have a frusto-conical shape or a generally spherical shape. The device insert 2 is a substantially solid porous material. In some embodiments, the substantially solid porous material of the device insert 2 may include fired clay. In some embodiments, the substantially solid porous material of the device insert 2 may include fired terracotta clay.

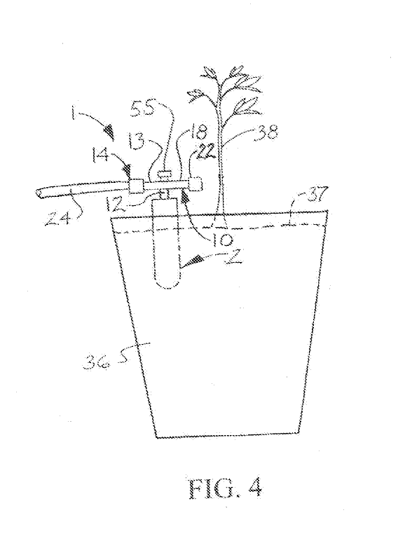

As illustrated in FIG. 3, at least one watering cavity 8 may extend from the upper insert surface 3 into the device insert 2 toward the lower insert surface 5. In some embodiments, the watering cavity 8 may be generally elongated, as illustrated, and may be disposed in generally parallel relationship with respect to a longitudinal axis of the device insert 2. In some embodiments, the watering cavity 8 may generally extend the entire length of the device insert 2, as illustrated in FIG. 3.

A water distribution conduit 10 is disposed in fluid communication with the watering cavity 8 of the device insert 2. The water distribution conduit 10 facilitates connection of the watering cavity 8 into fluid communication with the faucet 50 (FIG. 6) or other source of water or other liquid and may have any design which facilitates this purpose. Accordingly, as illustrated in FIGS. 1-3, in some embodiments the water distribution conduit 10 may include an insert neck 12 which communicates with the watering cavity 8. A first insert conduit 13 and a second insert conduit 18 may be disposed in fluid communication with the insert neck 12. As illustrated in FIG. 5, the first insert conduit 13 of the water distribution conduit 10 may include a female coupling 14. The female coupling 14 may include a coupling cavity 15 interior coupling threads 16 on the interior surface of the coupling cavity 15. The interior coupling threads 16 in the coupling cavity 15 of the female coupling 14 may be adapted to threadably engage exterior hose threads 25 on a hose 24 or other suitable conduit which may be conventional and may be coupled to the faucet 50 (FIG. 6). A male coupling 20 with exterior coupling threads 21 may be provided on the second insert conduit 18 of the water distribution conduit 10.

In some applications, the plant watering device 1 may be used to water plant growing medium 37 in a single plant container 36, as illustrated in FIG. 4 and will be hereinafter described. Accordingly, a cap 22 having interior cap threads (not illustrated) may be threaded on the male coupling 20 (FIG. 5) of the second insert conduit 18 to seal the second insert conduit 18. As illustrated in FIG. 6 and will be hereinafter described, in other applications, multiple hoses 24a-24c may be used to connect multiple plant watering devices 1a-1d to each other in series to water plant growing medium 37 in each of multiple plant containers 36. Accordingly, as illustrated in FIG. 5, the exterior coupling threads 21 on the male coupling 20 may engage interior hose coupling threads 32 in a female hose coupling 31 provided on a second or subsequent hose 24a-24c.

In some embodiments, an accessory neck 54 may extend from the water distribution conduit 10 in communication with the insert neck 12. A removable accessory cap 55 may be attached to the accessory neck 54 via threading or friction-fit, for example and without limitation. In application of the plant watering device 1, which will be hereinafter described, the accessory neck 54 may facilitate addition of amendments, fertilizer and/or other additives (not illustrated) to the watering cavity 8 of the device insert 2 as desired.

Referring next to FIGS. 4-6 of the drawings, in exemplary application, at least one plant watering device 1 distributes water 40 (FIG. 5) from a faucet 50 (FIG. 6) or other source of water 40 to plant growing medium 37 which in some applications may be contained in at least one plant container 36. The water 40 facilitates and supports the growth or life of at least one plant 38 in the plant growing medium 37. The plant 38 may be a decorative plant or a food plant such as a tomato plant, for example and without limitation. Accordingly, a hose 24 is coupled to the faucet 50 and to the female coupling 14 on the water distribution conduit 10 of the plant watering device 1. In some applications, one plant watering device 1 may be used to water plant growing medium 37 in one plant container 36, as illustrated in FIG. 4. Therefore, a cap 22 may be threaded on the male coupling 20 (FIG. 5) of the water distribution conduit 10 to seal and prevent discharge of the water 40 from the second insert conduit 18.

As illustrated in FIG. 6, in some applications, multiple plant watering devices 1a-1d may be connected in fluid communication with each other in series as part of a plant watering system 44 for the purpose of watering plant growing medium 37 in each of respective plant containers 36a-36d. Thus, as illustrated in FIG. 6, the female coupling 14 of a second plant watering device 1b is coupled to the male coupling 20 (FIG. 5) of the first plant watering device 1a through a second hose 24a. Similarly, a third plant watering device 1c may be coupled to the second plant watering device 1b through a third hose 24b. A fourth plant watering device 1d may additionally by coupled to the third plant watering device 1c through a fourth hose 24c. Additional plant watering devices 1 may be coupled in sequential order to the fourth plant watering device 1d through additional hoses 24. A cap 22 may be placed on the second insert conduit 18 of the terminal plant watering device 1 for sealing purposes, as illustrated with respect to the fourth plant watering device 1d in FIG. 6.

As illustrated in FIG. 5, the device insert 2 of each plant watering device 1 is inserted in the plant growing medium 37 in each plant container 36. The contact face 6 (FIGS. 1-3) of each device insert 2 may be disposed in direct contact with the plant growing medium 37, which may substantially surround the device insert 2. As illustrated in FIG. 5, water 40 flows from the faucet 50 (FIG. 6) through the hose 24 and then through the first insert conduit 13 and the insert neck 12, respectively, of the water distribution conduit 10 and finally into the watering cavity 8 of the device insert 2. Due to the positive pressure of the water 40 in the watering cavity 8, the water 40 enters the pores (not illustrated) in the solid porous medium of the device insert 2. Eventually, the water 40 saturates the pores in the device insert 2 until the water 40 seeps through the pores and emerges at the contact face 6 of the device insert 2. The plant growing medium 37, which is initially at a lower saturation level than the device insert 2, wicks or draws and absorbs the water 40 from the contact face 6 into the plant growing medium 37. It will be appreciated by those skilled in the art that the water 40 enters the plant growing medium 37 throughout substantially the entire surface area of the contact face 6. The rate of flow of the water 40 from the faucet 50 may be adjusted according to the watering requirements of the plant or plants 38 such as by adjusting the position of a faucet handle 51 (FIG. 6) on the faucet 50 typically in the conventional manner.

In the single-container application illustrated in FIG. 4, substantially the entire portion of the water 40 flows from the first insert conduit 13 and the second insert conduit 18 into the watering cavity 8 of the device insert 2 since the cap 22 prevents discharge of the water 40 from the water distribution conduit 10. In the multi-plant application illustrated in FIGS. 5 and 6, a first portion of the water 40 flows into the watering cavity 8 in the device insert 2 of the first plant watering device 1a and seeps through the solid porous material of the device insert 2 and is discharged into the plant growing medium 37 of the first plant container 36a. A second portion of the water 40 flows from the water distribution conduit 10 of the first plant watering device 1a, through the second hose 24a and into the water distribution conduit 10 of the second plant watering device 1b. A third portion of the water 40 flows into the watering cavity 8 of the second plant watering device 1b and seeps through the pores of the device insert 2 into the plant growing medium 37 in the second plant container 36b. A fourth portion of the water 40 flows from the water distribution conduit 10 of the second plant watering device 1b, through the third hose 24b and into the water distribution conduit 10 of the third plant watering device 1c. A fifth portion of the water 40 flows into the watering cavity 8 of the third plant watering device 1c and seeps through the pores of the device insert 2 into the plant growing medium 37 in the third plant container 36c. A final portion of the water 40 flows from the water distribution conduit 10 of the third plant watering device 1c, through the fourth hose 24c and into the water distribution conduit 10 of the fourth plant watering device 1d. The water 40 flows into the watering cavity 8 of the fourth plant watering device 1d and seeps through the pores of the device insert 2 into the plant growing medium 37 in the fourth plant container 36d. As the plant growing medium 37 which contacts and surrounds the device insert 2 of each plant watering device 1 becomes saturated with water 40, a progressively larger quantity of the water 40 flows from the plant watering device 1 to the next downstream plant watering device 1. In the foregoing manner, a sufficient quantity of water 40 is distributed to the plant growing medium 37 in each plant container 36 to ensure sufficient moisture to sustain growth and life of the plant or plants 38 in each plant container 36. In some applications, the accessory cap 55 can be removed from the accessory neck 54 to facilitate addition of fertilizer and/or other additives (not illustrated) to the watering cavity 8 through the accessory neck 54.

Referring next to FIG. 7 of the drawings, in some applications, multiple plant watering devices (designated 1a, 1b and 1c, respectively) may be connected with multiple hoses 24a, 24b, 24c. The first plant watering device 1a may be connected to a faucet 50 (FIG. 6) or other suitable water source through a first hose 24. Liquid fertilizer 41 may be placed in the watering cavity 8 of the first plant watering device 1a. Accordingly, upon opening of the faucet 50, water 40 flows from the faucet 50 through the first hose 24 and the water distribution conduit 10 and into the watering cavity 8 of the first plant watering device 1a. In the watering cavity 8, the water 40 mixes with the liquid fertilizer 41 and seeps through the pores in the solid porous material of the device insert 2 of the first plant watering device 1a into the surrounding plant growing medium 37 (FIG. 5) in the first plant container 36a (FIG. 6). A portion of the liquid/fertilizer mixture 42 is aspirated from the watering cavity 8 of the first plant watering device 1a through the water distribution conduit 10, and then flows through the second hose 24a to the second plant watering device 1b.

The liquid/fertilizer mixture 42 flows through the water distribution conduit 10 into the watering cavity 8 of the second plant watering device 1b, from which the liquid/fertilizer mixture 42 seeps through the solid porous material of the device insert 2 of the second plant watering device 1b into the surrounding plant growing medium 37 (FIG. 5) in the second plant container 36b. A portion of the liquid/fertilizer mixture 42 is aspirated from the watering cavity 8 and through the water distribution conduit 10 of the second plant watering device 1b, and then flows through the third hose 24b to the third plant watering device 1c. In the foregoing manner, both water 40 and liquid fertilizer 41 are distributed from the first plant watering device 1a to each of the remaining plant watering devices 1b, 1c which are disposed in fluid communication with the first plant watering device 1a to sustain the growth or life of plants 38 contained in multiple plant containers 36. In applications in which a large number of plant watering devices 1 are connected to each other, it will be appreciated by those skilled in the art that a supply of liquid fertilizer 41 can initially be placed in the watering cavity 8 of each of multiple plant watering devices 1 to ensure that a sufficient quantity of the liquid fertilizer 41 is distributed to the plant growing medium 37 of each plant container 36.

While the preferred embodiments of the disclosure have been described above, it will be recognized and understood that various modifications can be made in the disclosure and the appended claims are intended to cover all such modifications which may fall within the spirit and scope of the disclosure.

What is claimed is:

1. A plant watering device, comprising:
a device insert having a substantially solid porous material with a continuously porous exterior contact face;
at least one watering cavity in the device insert; and
a water distribution conduit disposed in fluid communication with the at least one watering cavity.

2. The plant watering device of claim 1 wherein the device insert is generally elongated.

3. The plant watering device of claim 2 wherein the device insert is generally cylindrical.

4. The plant watering device of claim 2 wherein the at least one watering cavity extends generally an entire length of the device insert.

5. The plant watering device of claim 1 wherein the substantially solid porous material comprises clay.

6. The plant watering device of claim 5 wherein the clay comprises terracotta clay.

7. The plant watering device of claim 1 wherein the water distribution conduit comprises a first insert conduit and a second insert conduit disposed in fluid communication with the watering cavity.

8. The plant watering device of claim 7 further comprising an insert neck disposed in fluid communication with the watering cavity and wherein the first insert conduit and the second insert conduit are disposed in fluid communication with the insert neck.

9. A plant watering device, comprising:
a device insert having a substantially solid porous material and a continuously porous exterior contact face;
at least one watering cavity in the device insert;
a water distribution conduit disposed in fluid communication with the watering cavity;
a first coupling carried by the water distribution conduit;
a second coupling carried by the water distribution conduit; and
an accessory neck disposed in fluid communication with the water distribution conduit.

10. The plant watering device of claim 9 wherein the first coupling comprises a female coupling and the second coupling comprises a male coupling.

11. The plant watering device of claim 9 wherein the device insert is generally elongated.

12. The plant watering device of claim 11 wherein the device insert is generally cylindrical.

13. The plant watering device of claim 11 wherein the at least one watering cavity extends generally an entire length of the device insert.

14. The plant watering device of claim 9 wherein the substantially solid porous material comprises clay.

15. The plant watering device of claim 14 wherein the clay comprises terracotta clay.

16. The plant watering device of claim 9 wherein the water distribution conduit comprises a first insert conduit and a second insert conduit disposed in fluid communication with the watering cavity, and wherein the first coupling is carried by the first insert conduit and the second coupling is carried by the second insert conduit.

17. The plant watering device of claim 16 further comprising an insert neck disposed in fluid communication with the watering cavity and wherein the first insert conduit and the second insert conduit are disposed in fluid communication with the insert neck.

18. A plant watering system, comprising:
a water source;
a plurality of interconnected plant watering devices each including:
a device insert having a substantially solid porous material with a continuously porous exterior contact face;
at least one watering cavity in the device insert; and
a water distribution conduit disposed in fluid communication with the at least one watering cavity and with the water source; and
a conduit establishing fluid communication between the water distribution conduit of each of the plant watering devices and the water distribution conduit of each adjacent one of the plant watering devices.

19. The plant watering system of claim 18 wherein the substantially solid porous material comprises clay.

20. The plant watering system of claim 19 wherein the clay comprises terracotta clay.
